(19) United States
(12) Patent Application Publication
(10) Pub. No.: US 2016/0303581 A1
(43) Pub. Date: Oct. 20, 2016

(54) MODULAR STRUCTURE SHOWER DEVICE

(71) Applicant: Xiamen Runner Industrial Corporation, Xiamen (CN)

(72) Inventors: Min Li, Xiamen (CN); Lei Hou, Xiamen (CN); Shunchuan Zheng, Xiamen (CN)

(21) Appl. No.: 15/097,972

(22) Filed: Apr. 13, 2016

(30) Foreign Application Priority Data
Apr. 18, 2015 (CN) 201510186802.0

(51) Int. Cl. B05B 1/18; B05B 15/06; B05B 1/30

(52) U.S. Cl. CPC B05B 1/185; B05B 1/3026; B05B 15/061

(57) ABSTRACT

A modular structure shower device includes a hood cover set, provided with a shower face used to output water; a back seat set, connected to a rear portion of the hood cover set through a water channel; and a handle set, connected to a lower portion of the hood cover set through the water channel. The modular structure shower device is novel in design, simple in construction, easy to install and detach, convenient to use, as such it is able to satisfy demands of various users and ensure normal operation.

### BACKGROUND OF THE INVENTION

1. Field of the Invention

The present invention relates to a shower device, and in particular to a modular structure shower device.

2. The Prior Arts

In general, for the bathing equipment utilized in a bathroom, such as, a shower or a shower head, its structure is rather fixed. For example, when using a shower, its shower face and shower handle are fixedly connected and can not be detached; and there are no water channels between the shower face and the base seat. As such, when the existing water channel of the shower is in fault, no water supply is available, such that the shower can not be used at all, thus causing inconvenience to the user.

Therefore, presently, the design and performance of the shower device is not quite satisfactory, and it leaves much room for improvement.

### SUMMARY OF THE INVENTION

In view of the problems and drawbacks of the prior art, the present invention provides a modular structure shower device, to overcome the shortcomings of the prior art.

In order to achieve the objective mentioned above, the present invention provides a modular structure shower device, including: a hood cover set, provided with a shower face used to output water; a back seat set, connected to a rear portion of the hood cover set through a water channel; and a handle set, connected to a lower portion of the hood cover set through the water channel.

In the structure mentioned above, the hood cover set includes: a shower main body; a shower back cover, connected to the shower main body through water channel; a first water input port, disposed on the shower back cover; a second water input port, disposed on the shower back cover; a first check valve, disposed in the front end face of the shower main body; a second check valve, disposed in the front end face of the shower main body; a through hole, disposed in a center of a back end face of the shower main body, and connected to the first check valve through a water channel; a positioning rod, disposed in a center of the through hole, and located on a back end face of the shower back cover; a float cover, sleeved around the positioning rod, and in the through hole; and a core axis, disposed at a lower portion of the shower main body, and connected to the second check valve through the water channel.

The back seat set includes: a back seat main body; a back seat cover, connected to a front end of the back seat main body, and disposed in the through hole of the shower main body; a ball head, connected to a back end of the back seat main body; a back seat core, disposed in the back seat main body located between the ball head and the back seat cover; a third check valve, disposed in the back seat core; and a fastening claw, disposed in the back seat core, to be driven by a positioning rod to press against the third check valve.

The handle set includes: a handle main body, provided with a water output hole, with its lower portion provided with a third water input port; a cover plate, disposed in an upper portion of the handle main body, to connect to the core axis; and a movable valve rod, disposed in the cover plate, to be driven by the core axis to control the handle set to supply water to the hood cover set.

In addition, the present invention further includes a first restoring spring, disposed between the shower back cover and a back end face of the shower main body.

Moreover, the present invention further includes a fastening hook, through which the fastening claw is connected to the back seat core; a third restoring spring, disposed between the fastening claw and the third check valve; and a press cover, disposed in a claw port of the fastening claw, pressed to connect to the positioning rod, and is pressed onto the fastening hook.

Furthermore, the present invention further includes a water stop press button, disposed on the handle main body, and between the movable valve rod, and a third water input port at a lower portion of the handle main body.

In addition, the present invention further includes a second restoring spring, disposed between the second check valve and the core axis.

Moreover, the present invention further includes a fastening slot, disposed on the back seat core to fasten the fastening hook at different positions.

Furthermore, the present invention further includes a fastening and connection component, disposed on a cover plate located on the handle main body, for connecting/disconnecting the core axis onto/from the cover plate; the fastening and connection component includes a fastening tongue, a press plate, a spring, and a press button.

Compared with the Prior Art, the present invention has the advantages that, it is novel in design, simple in construction, easy to install and detach, convenient to use, as such it is able to satisfy demands of various users and ensure normal operation.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a modular structure shower device according to an embodiment of the present invention;

FIG. 2 is an exploded view of a modular structure shower device according to an embodiment of the present invention;

FIG. 3 is a schematic diagram of a water output structure of solution 1 according to an embodiment of the present invention;

FIG. 4 is a schematic diagram of a water output structure of solution 2 according to an embodiment of the present invention; and

FIG. 5 is a schematic diagram of a water output structure of solution 3 according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

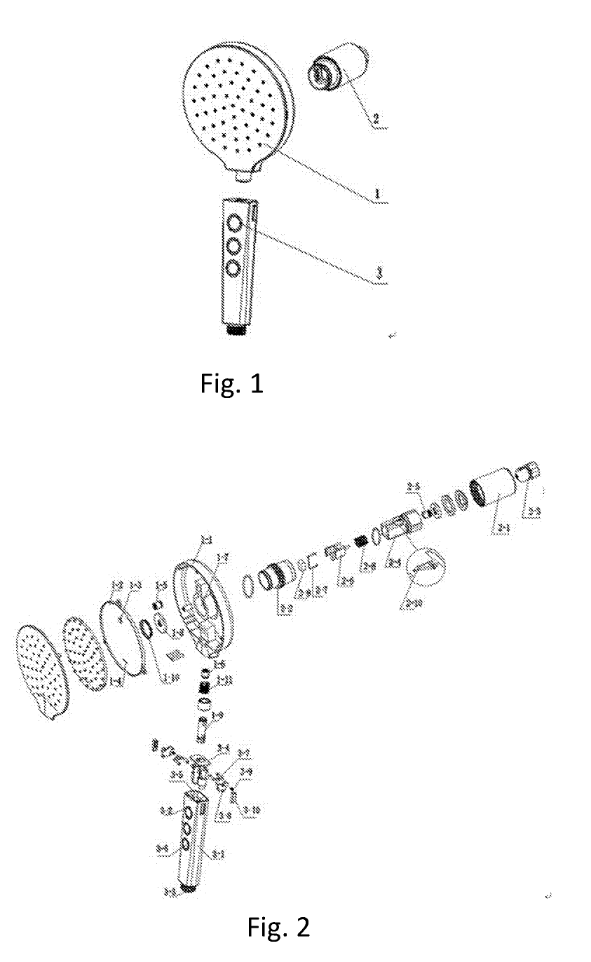

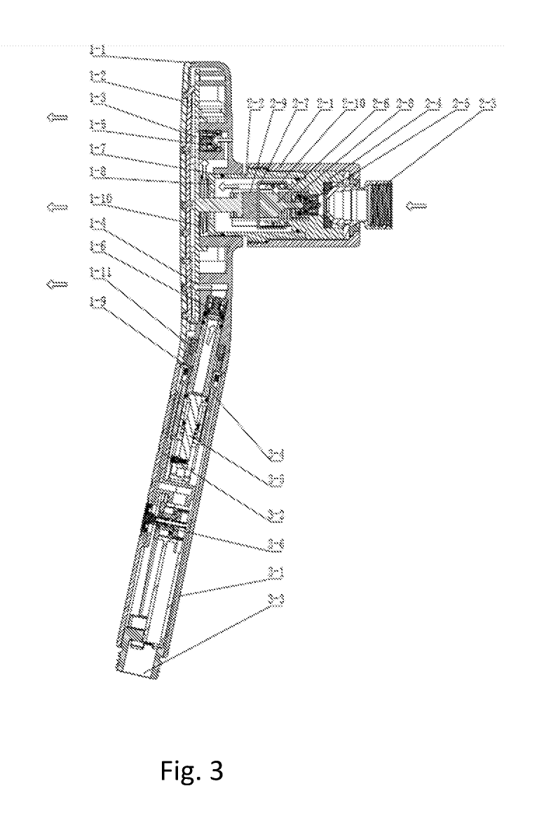

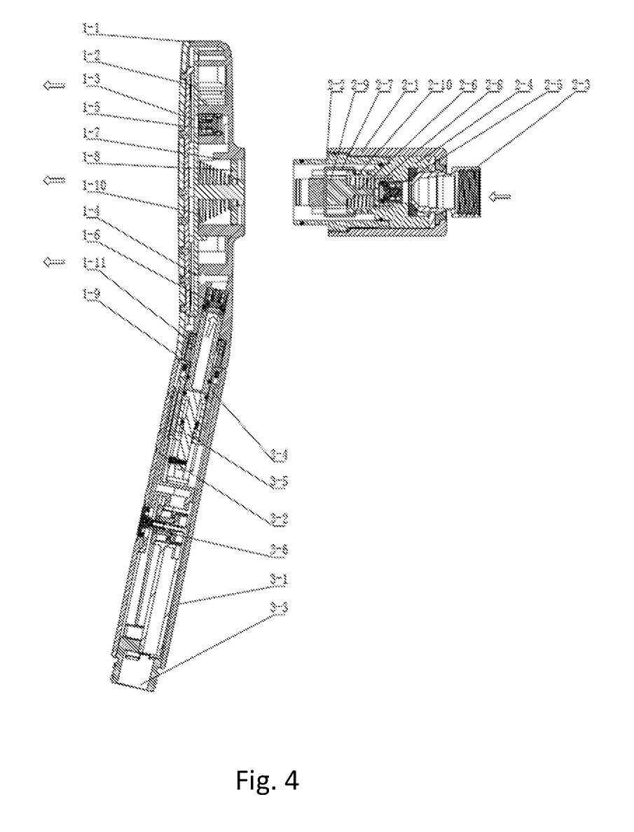

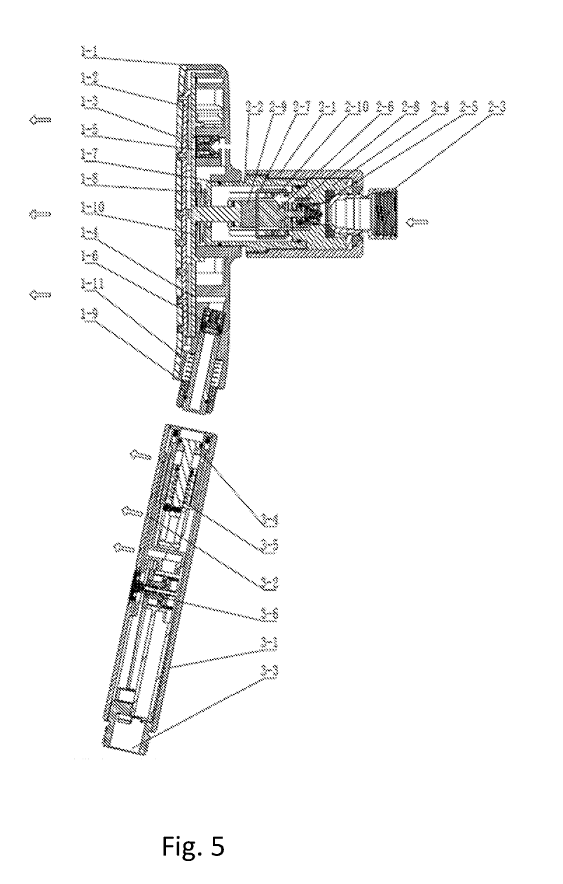

Refer to FIGS. 1 to 5 respectively for a schematic diagram of a modular structure shower device according to an embodiment of the present invention; an exploded view of a modular structure shower device according to an embodiment of the present invention; a schematic diagram of a water output structure of solution 1 according to an embodiment of the present invention; a schematic diagram of a water output structure of solution 2 according to an embodiment of the present invention; and a schematic diagram of a water output structure of solution 3 according to an embodiment of the present invention.

As shown in FIGS. 1 to 5, the present invention provides a modular structure shower device, including: a hood cover set 1, provided with a shower face used to output water; a back seat set 2, connected to a rear portion of the hood cover set 1 through a water channel; and a handle set 3, connected to a lower portion of the hood cover set 1 through the water channel.

In the structure mentioned above, the hood cover set 1 includes: a shower main body 1-1; a shower back cover 1-2, connected to the shower main body 1-1 through water channel; a first water input port 1-3, disposed on the shower back cover 1-2; a second water input port 1-4, disposed on the shower back cover 1-2; a first check valve 1-5, disposed in the front end face of the shower main body 1-1; a second check valve 1-6, disposed in the front end face of the shower main body 1-1; a through hole 1-7, disposed in a center of a back end face of the shower main body 1-1, and connected to the first check valve 1-5 through a water channel; a positioning rod, disposed in a center of the through hole 1-7, and located on a back end face of the shower back cover 1-2; a float cover 1-8, sleeved around the positioning rod, and in the through hole 1-7; and a core axis 1-9, disposed at a lower portion of the shower main body 1-1, and connected to the second check valve 1-6 through the water channel.

The back seat set 2 includes: a back seat main body 2-1; a back seat cover 2-2, connected to a front end of the back seat main body 2-1, and disposed in the through hole 1-7 of the shower main body 1-1; a ball head 2-3, connected to a back end of the back seat main body 2-1; a back seat core 2-4, disposed in the back seat main body 2-1 located between the ball head 2-3 and the back seat cover 2-2; a third check valve 2-5, disposed in the back seat core 2-4; and a fastening claw 2-6, disposed in the back seat core 2-4, to be driven by a positioning rod to press against the third check valve 2-5.

The handle set 3 includes: a handle main body 3-1, provided with a water output hole 3-2, with its lower portion provided with a third water input port 3-3; a cover plate 3-4, disposed in an upper portion of the handle main body 3-1, to connect to the core axis 1-9; and a movable valve rod 3-5, disposed in the cover plate 3-4, to be driven by the core axis 1-9 to control the handle set 3 to supply water to the hood cover set 1.

In addition, the present invention further includes a first restoring spring 1-10, disposed between the shower back cover 1-2 and a back end face of the shower main body 1-1.

Moreover, the present invention further includes a fastening hook 2-7, through which the fastening claw 2-6 is connected to the back seat core 2-4; a third restoring spring 2-8, disposed between the fastening claw 2-6 and the third check valve 2-5; and a press cover 2-9, disposed in a claw port of the fastening claw 2-6, pressed to connect to the positioning rod, and is pressed onto the fastening hook 2-7.

Furthermore, the present invention further includes a water stop press button 3-6, disposed on the handle main body 3-1, and between the movable valve rod 3-5, and a third water input port 3-3 at a lower portion of the handle main body 3-1.

In addition, the present invention further includes a second restoring spring 1-11, disposed between the second check valve 1-6 and the core axis 1-9.

Moreover, the present invention further includes a fastening slot 2-10, disposed on the back seat core 2-4 to fasten the fastening hook 2-7 at different positions.

Furthermore, the present invention further includes a fastening and connection component, disposed on a cover plate 3-4 located on the handle main body 3-1, for connecting/disconnecting the core axis 1-9 onto/from the cover plate 3-4; the fastening and connection component includes a fastening tongue 3-7, a press plate 3-8, a spring 3-9, and a press button 3-10.

The implementation of the present invention is described as follows:

### Operation Principle (Solution 1) for the Condition that the Handle Set, the Hood Cover Set, and the Back Seat Set Are Assembled and Attached Together

Water route 1: water is input from the third water input port of the handle set. Due to the pushing force of the core axis, a movable seal rod is moved downward, to open the water output port. Then, the input water flows through inside the core axis toward the second check valve. Due to the pushing force of the input water, the second check valve is opened, so that water flows out from the hood cover.

Water route 2: water is input from the water input port of the ball head of the back seat set, the fastening claw pushes the third check valve to open, so that water can flow through the third check valve to the first check valve. Due to the pushing force of the input water, the first check valve is opened, so that water flows out from the hood cover.

In the descriptions above, the water stop press button of the handle set is used to switch to open/close the water output hole of the handle set.

### Operation Principle (Solution 2) for the Condition that the Handle Set, the Hood Cover Set Are Assembled and Attached Together, while the Back Seat Set is Detached

Water route 1: water is input from the third water input port of the handle set. Due to the pushing force of the core axis, a movable seal rod is moved downward, to open the water output port. Then, the input water flows through inside the core axis toward the second check valve. Due to the pushing force of the input water, the second check valve is opened, so that water flows out from the hood cover. Meanwhile, due to the action of the first check valve, water is not allowed to flow out from the back end face of the hood cover set.

Water route 2: water is input from the water input port of the ball head of the back seat set, due to the action of the third check valve, water is not allowed to flow out from the back seat set.

In the descriptions above, the water stop press button of the handle set is used to switch to open/close the water output hole of the handle set.

### Operation Principle (Solution 3) for the Condition that the Hood Cover Set and the Back Seat Set Are Assembled and Attached Together, while the Handle Set is Detached

Water route 1: water is input from the third water input port of the handle set, while the movable seal rod is in a seal state, so that water is not allowed to flow out form the end face of the handle set.

Water route 2: water is input from the water input port of the ball head of the back seat set, the fastening claw pushes the third check valve to open, so that water can flow through the third check valve to the first check valve. Due to the pushing force of the input water, the first check valve is opened, so that water flows out from the hood cover. Meanwhile, due to the action of the second check valve, water is not allowed to flow out from the lower end face of the hood cover set.

In the descriptions above, the water stop press button of the handle set is used to switch to open/close the water output hole of the handle set.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A modular structure shower device, comprising:
a hood cover set, provided with a shower face used to output water;
a back seat set, connected to a rear portion of the hood cover set through a water channel; and
a handle set, connected to a lower portion of the hood cover set through the water channel.

2. The modular structure shower device as claimed in claim 1, wherein the hood cover set includes:
a shower main body;
a shower back cover, connected to the shower main body through water channel;
a first water input port, disposed on the shower back cover;
a second water input port, disposed on the shower back cover;
a first check valve, disposed in the front end face of the shower main body;
a second check valve, disposed in the front end face of the shower main body;
a through hole, disposed in a center of a back end face of the shower main body, and is connected to the first check valve through a water channel;
a positioning rod, disposed in a center of the through hole, and is located on a back end face of the shower back cover;
a float cover, sleeved around the positioning rod, and in the through hole; and
a core axis, disposed at a lower portion of the shower main body, and connected to the second check valve through the water channel.

3. The modular structure shower device as claimed in claim 1, wherein the back seat set includes:
a back seat main body;
a back seat cover, connected to a front end of the back seat main body, and disposed in the through hole of the shower main body;
a ball head, connected to a back end of the back seat main body;
a back seat core, disposed in the back seat main body located between the ball head and the back seat cover;
a third check valve, disposed in the back seat core; and
a fastening claw, disposed in the back seat core, to be driven by a positioning rod to press against the third check valve.

4. The modular structure shower device as claimed in claim 1, wherein the handle set includes:
a handle main body, provided with a water output hole, with its lower portion provided with a third water input port;
a cover plate, disposed in an upper portion of the handle main body, to connect to the core axis; and
a movable valve rod, disposed in the cover plate, to be driven by the core axis to control the handle set to supply water to the hood cover set.

5. The modular structure shower device as claimed in claim 2, further comprising:
a first restoring spring, disposed between the shower back cover and a back end face of the shower main body.

6. The modular structure shower device as claimed in claim 3, further comprising:
a fastening hook, through which the fastening claw is connected to the back seat core;
a third restoring spring, disposed between the fastening claw and the third check valve; and
a press cover, disposed in a claw port of the fastening claw, pressed to connect to the positioning rod, and is pressed onto the fastening hook.

7. The modular structure shower device as claimed in claim 4, further comprising:
a water stop press button, disposed on the handle main body, and between the movable valve rod, and a third water input port at a lower portion of the handle main body.

8. The modular structure shower device as claimed in claim 2, further comprising:
a second restoring spring, disposed between the second check valve and the core axis.

9. The modular structure shower device as claimed in claim 3, further comprising:
a fastening slot, disposed on the back seat core to fasten the fastening hook at different positions.

10. The modular structure shower device as claimed in claim 4, further comprising:
a fastening and connection component, disposed on a cover plate located on the handle main body, for connecting/disconnecting the core axis onto/from the cover plate; the fastening and connection component includes a fastening tongue, a press plate a spring, and a press button.
